(19) United States
(12) Patent Application Publication
(10) Pub. No.: US 2003/0135754 A1
(43) Pub. Date: Jul. 17, 2003

(54) Database expanding system and method

(76) Inventors: Chaucer Chiu, Taipei (TW); Hong-Bing Zhang, Shanghai (CN)

Correspondence Address: BIRCH STEWART KOLASCH & BIRCH, PO BOX 747, FALLS CHURCH, VA, 22040-0747, US

(21) Appl. No.: 10/042,207

(22) Filed: Jan. 11, 2002

(51) Int. Cl. H04L 9/32

(52) U.S. Cl. 713/201; 713/189

(57) ABSTRACT

A system and method for expanding a database, after connecting to a database website, a client end may choose databases from the database website and pay for the selected database. Payment allows a client end to gain a number of database download and installation times for downloading and installing the database. An authentication code is then sent back to the database website. When the authentication code is verified, the system returns an authentication approval message to the client end. After the client end receives the authentication approval message, the database is encrypted with the authentication code. Finally, the client end is able to completely install the encrypted database on line. Thus, the copyright of the database is securely protected.

### BACKGROUND OF THE INVENTION

1. Field of the Invention

The invention relates to a system and method for expanding a database, in particular, a cryptographic process to securely protect the copyright of the database.

2. Related Art

With the increase in popularity of the Internet, lots of information and software can be found and freely downloaded from the Internet. This is because some authors regard the Internet as a new marketplace, so it is mainly free of charge for using information and software at the beginning for the purpose of advertising on the Internet. For that information and software that becomes well-known, the concept of “Pay for using/pay per usage” is considered to protect an author's copyright. However, this concept has not yet been deep-rooted in the public, and consumers are still used to free information (or software). Some consumers even provide information (or software) they have purchased to their friends for use. Thus, the author's copyright cannot be securely protected.

Because of the above-mentioned reasons, how to permit legal users to download information (or software) on-line and protect copyrights to prevent freely using information (or software) without paying has become an issue of great concern.

### SUMMARY OF THE INVENTION

The main object of the invention is to provide a kind of system and method that securely protects the copyright of a database without hindering users' ability to download, and to expand the database.

The invention operates as a system including a database website to which a client end connects. The database website includes a storage unit for storing several kinds of database, a download unit for selecting and database downloading functions, and an authentication unit for legalizing the database installation from the client end. The client end includes a storage and installation module for the client end to store and download the database, an authentication module for sending the authentication code from the client end to the authentication unit, and a decryption module for decrypting the authentication code to the database.

The method of the invention is that after selecting a database in the database website and paying for the selected database at a client end, the client is given a number of download and installation times for downloading and installing the database on line. Then, when the client end downloads and installs the database and sends the authentication code to the database website, the database website verifies the authentication code and sends back an authentication approval message to the client end. After the client end receives the approval message, the database is encrypted with the authentication code. Thus, the client end is able to completely install the encrypted database on line.

For more acquaintance with the achievements, structural characteristics, and functions of the invention, a detailed description is provided as follows:

### DETAIL DESCRIPTION OF A PREFERRED EMBODIMENT

The disclosed system and method for expanding a database allows a client end to connect with the database website and obtain a certain number of download and installation times for downloading and installing on-line after selecting and paying for the chosen database.

As shown in FIG. 1, the expanded system of a database includes the database website 10 to which a client end 20 connects. Within the database website 10 there is a storage unit 11, a download unit 12, and an authentication unit 13. The storage unit 11 stores several kinds of databases, while the download unit 12 provides the function of selecting and downloading the database for the storage unit 11 and includes a recorder 121 for recording the times of downloading and installing the database. Moreover, the authentication unit 13, which provides the client end 20 with the validity confirmation of installing the database, includes an encryption and decryption maker 131 to encrypt and decrypt messages being sent.

The client end 20 includes a storage and installation module 21, an authentication module 22, and a decryption module 23. The storage and installation module 21 allows the client end 20 to store and install the database downloaded by the download unit 12, and includes an encryption maker 211 to encrypt the message sent between the database and the client end 20. The authentication module 22 sends the authentication code, which can be a client end's ID, password, and hard disk serial number, or a client end's ID, password, and manufacture/production number, from the client end 20 to the authentication unit 13. The decryption module 23 decrypts the database with the authentication code and messages received from the client end 20.

While operating, the client end 20 first connects to the database website 10. The client end 20 then utilizes the download unit 12 for selecting and downloading the database of the storage unit 11, and downloads and installs data to the storage and installation module 21. In the meantime, before completely installing the database to the storage and installation module 21, the authentication module 22 sends the authentication code of the client end 20 to the authentication unit 13 on the database website 10 for confirming the identity of the client end 20. After confirmation, the authentication module 22 receives the authentication approval message from the authentication unit 13, and sends it to the storage and installation module 21 utilizing the encryption maker 211 to encrypt the database with the authentication code. Moreover, the storage and installation module 21 installs the encrypted database on line. The decryption module 13 utilizes the authentication code to decrypt the database when it is operated.

At the same time the authentication unit 13 confirms the validity of the installation, the recorder 121 records the times of the database being downloaded and installed in order to verify whether the database download and installation is still valid. Then, the authentication unit 13 also sends the authentication approval message to the authentication module 22 for the purpose of comparing the above-mentioned hard disk serial number in the authentication code with the hard disk serial number of the client end 20 in the previous database download and installation. If any difference is found, the recorder 121 renews download and installation times (which can be either downloaded and installed time or remaining downloading and installing time). When there is no difference, the recorder 121 does not renew the download and installation times. The same comparison can also be made with the manufacture/production number in the authentication code.

Moreover, the decryption module 23, the encryption maker 211, and the encryption and decryption maker 131 of the authentication unit 13 can utilize encryption and decryption mechanisms in the processes of sending the authentication code and the authentication approval message. Moreover, the installation time of the client end 20 is utilized for implementing encryption and decryption mechanisms to ensure the confidentiality of the authentication code and the authentication approval message.

As shown in FIG. 2, the disclosed method for expanding the database of the invention provides the client end with a connection to the database website, where a plurality of databases are stored. Furthermore, the client end retrieves a number of download and installation times for downloading and installing on-line after paying for the chosen database. The steps of the method are as follows:

Firstly, start the flow of the method (step 100);

The client end selects the database on the database website (step 101);

The client end then pays for the chosen database (step 102) and gains a number of download and installation times for downloading and installing on-line (step 103). The download and installation can be either downloaded and installed time or remaining downloading and installing time;

Then, the client end downloads and installs the database (step 104),

and sends the authentication code to the database website (step 105). The authentication code can be a client end's ID, password, and hard disk serial number, or a client end's ID, password, and manufacture/production number.

When the authentication code is confirmed, the database website sends an authentication approval message back to the client end (step 106);

After the client end receives the authentication approval message (step 107),

the database is encrypted with the authentication code (step 108);

then the client end can completely install the database on line (step 109).

Finally, the flow is finished (step 110).

As shown in FIG. 3, another step of decrypting the database with the authentication code can be performed (step 1091) following the aforementioned step 109 to enable the database to be decrypted when a client end operates the database.

Moreover, another step of using the database installing time to encrypt the authentication code at the client end (step 1041) can even be included prior to the step 105 of sending the authentication code to the database website. Also, following step 105, there can be another step of decrypting the authentication code at the database website (step 1051). As shown in FIG. 4, step 106 indicates that after being encrypted with the installation time of the client end, the authentication approval message is sent back to the client end. Furthermore, step 106 also includes the step of confirming the difference between the authentication code and previous authentication code while the database is being downloaded and installed at the client end (step 1061), and the step of renewing the number of download and installation times (step 1062). Step 107 includes the step of decrypting the authentication approval message.

The Effectiveness of the Invention

The disclosed invention is a system and method for expanding a database to provide the following advantages:

1. A client end can freely select the database required, without being forced to accept and be charged for any other databases.

2. The publishing of the database is simple and convenient to implement, and with the characteristics of low-cost, rapidity, and boundless time and space.

3. The copyright of the database website can be strictly protected by the invention to preserve the rights of authors, publishers and merchants.

4. The disclosed invention does not inhibit the downloading capabilities of a client end because: (1) a client end can download the database paid for an unlimited number of times. (2) When any damage occurs at the client end, or a purchased database needs to be upgraded, a client end can still download or install the database that paid under the same harddisk serial number (or manufacture number). (3) If the hardware of the client end is upgraded, installation can be done during certain approved times (the download and installation times). (4) Within these approved times, the database can be installed at different client ends.

An invention is disclosed herein. These and other variations, which will be understood by those skilled in the art, are within the intended scope of the invention as claimed below. As previously stated, detailed embodiments of the invention are disclosed herein; however, it is to be understood that the disclosed embodiments are merely exemplary of the invention that may be embodied in various forms.

### BRIEF DESCRIPTION OF THE FIGURES

FIG. 1 is a systematic representation of the expanding database system and method of the invention.

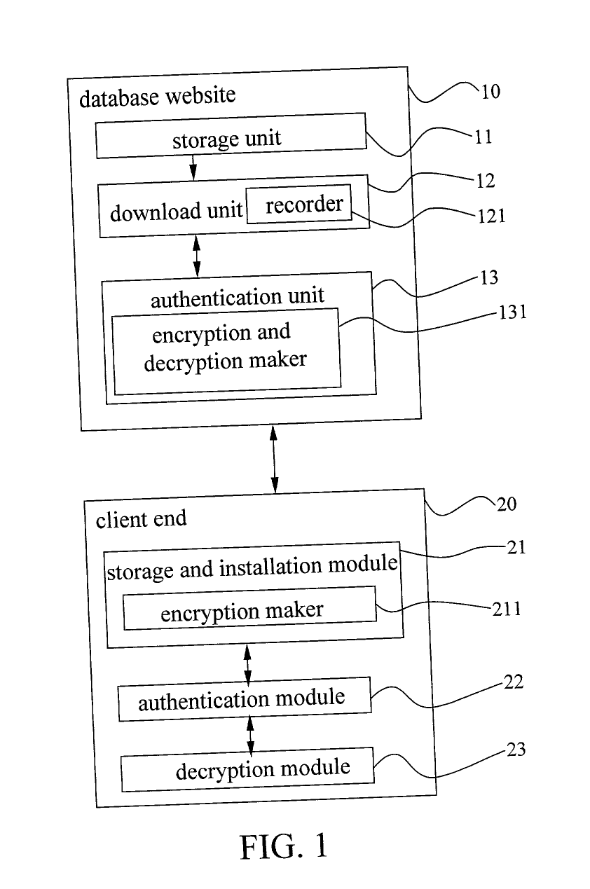

FIG. 2 is a methodical flowchart of the expanding database system and method of the invention; and

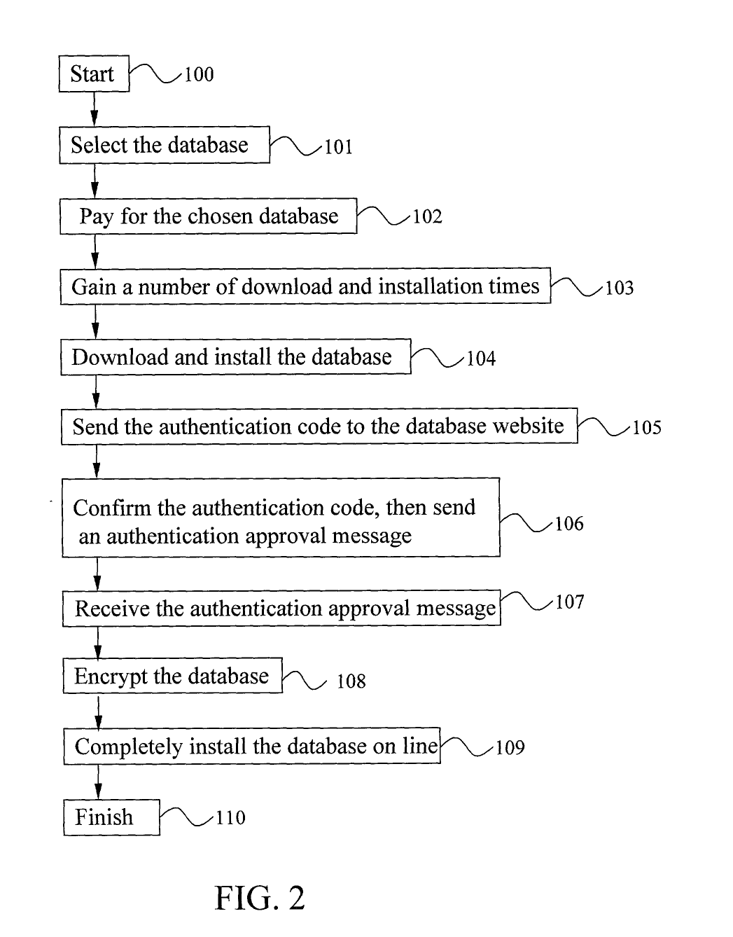

FIG. 3 is another methodical flowchart of the expanding database system and method of the invention.

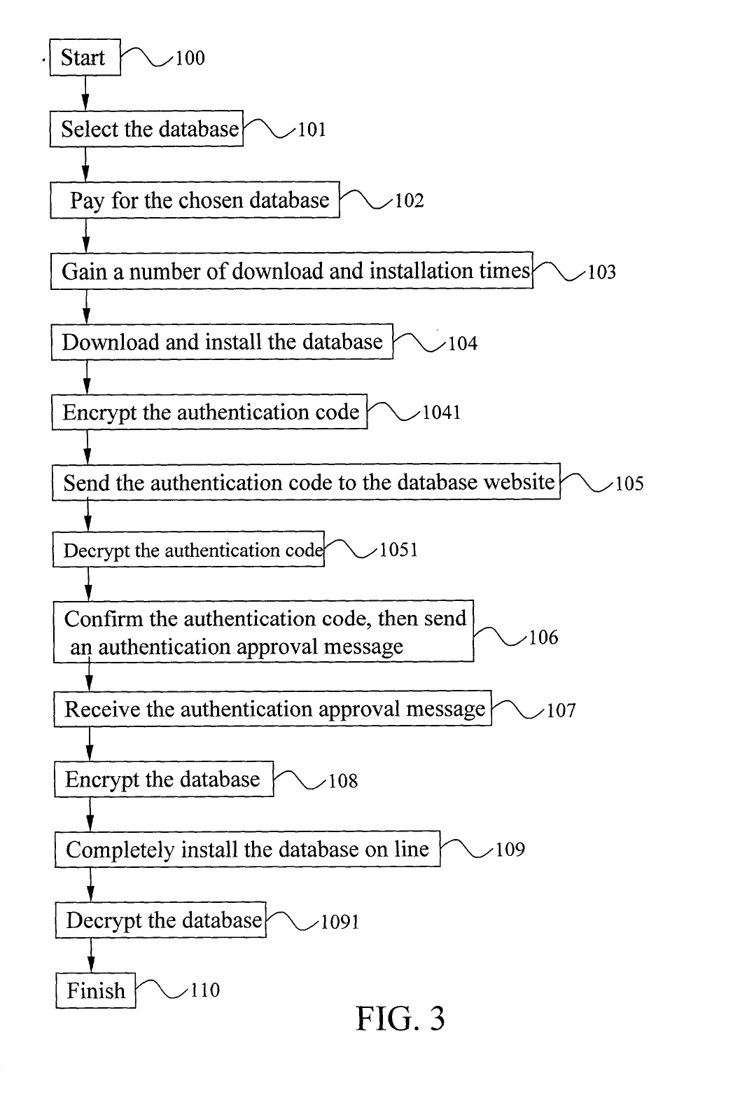

FIG. 4 is the detail flowchart of the step 106 in FIG. 2 and FIG. 3.

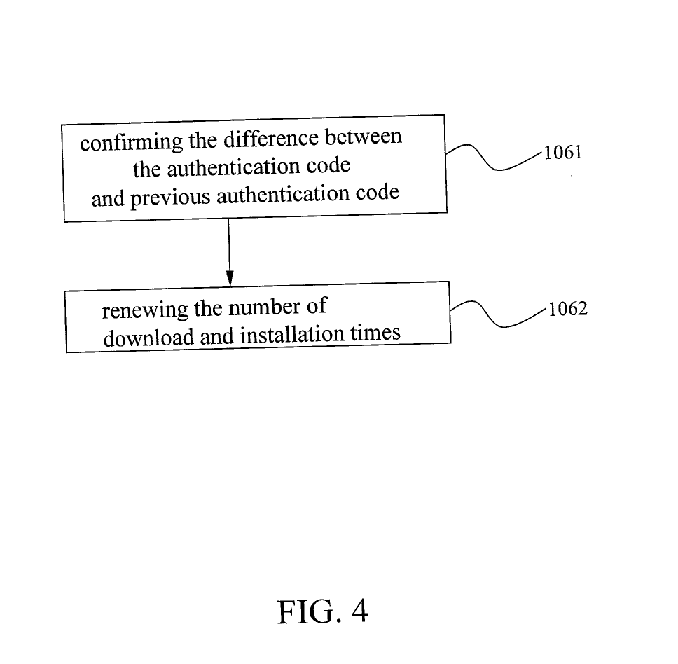

What is claimed is:

1. A system for expanding the database includes:
a database website including:
a storage unit for storing a plurality of databases;
a download unit for selecting and downloading the database of the storage unit;
an authentication unit for confirming the validity of installing the database;
a client end, with a connection to the database website, for choosing the database from the download unit and then retrieving a number of download and installation times for downloading and installing on-line after paying for the chosen database, the client end includes:
a storage and installation module for storing and installing the database downloaded from the download unit, and contains an encryption maker for encrypting the database; and
an authentication module for sending one authentication code of the client end to the authentication unit before complete installation of the storage and installation module, and an authentication approval message is received from the authentication unit and sent to the storage and installation module to encrypt the database with the authentication code by the encryption maker after confirmed, then the storage and installation module completely installs the encrypted database on line.

2. The invention as recited in claim 1, wherein the client end further includes a decryption module which utilizes the authentication code to decrypt the database when the database being operated.

3. The invention as recited in claim 2, wherein the decryption module, the encryption maker, and one encryption and decryption maker of the authentication unit further utilize for encrypting and decrypting the authentication code and the authentication message which needs to be sent.

4. The invention as recited in claim 3, wherein the decryption module, the encryption maker, and the encryption and decryption maker of the authentication unit encrypt and decrypt the database with database installing time of the client end.

5. The invention as recited in claim 1, wherein the download unit further includes a recorder for recording the times of downloading and installing the database to confirm if download and installation is still valid by checking the authentication code.

6. The invention as recited in claim 5, wherein the authentication code is the client end's ID, password, and harddisk serial number.

7. The invention as recited in claim 6, wherein when the harddisk serial number differs from the harddisk serial number of previous database download and installation, the recorder renews the download and installation times.

8. The invention as recited in claim 7, wherein the download and installation times are download and installation times, which have been already made.

9. The invention as recited in claim 7, wherein the download and installation times are remaining download and installation times.

10. The invention as recited in claim 5, wherein the authentication code is the client end's ID, password, and manufacture number.

11. The invention as recited in claim 10, wherein when the manufacture number differs from the manufacture number of previous database download and installation, the recorder renews the download and installation times.

12. The invention as recited in claim 11, wherein the download and installation times are download and installation, which have been already made.

13. The invention as recited in claim 11, wherein the download and installation times are remaining download and installation times.

14. A method for expanding the database, which a client end utilizes for connecting a database website where stores plurality of databases, and for selecting, downloading and installing the database, the method includes the steps of:
selecting the database;
paying for the chosen database;
gaining a number of download and installation times of the database for downloading and installing on line;
downloading and installing the database;
sending an authentication code to the database website;
vervifying the authentication code, and sending back an authentication approval message through the database website;
receiving the authentication approval message;
encrypting the database with the authentication code; and
completely install the encrypted database on line.

15. The invention as recited in claim 14, wherein the step of completely installing the encrypted database on line further includes a step of decrypting the database with the authentication code.

16. The invention as recited in claim 14 includes a step of encrypting the authentication code with the time of installing the database at the client end prior to the step of sending an authentication code to the database website.

17. The invention as recited in claim 16, wherein the step of sending an authentication code to the database website further includes a step of decrypting the authentication code by the database website.

18. The invention as recited in claim 14, wherein the authentication approval message is sent back after being encrypted with the database installation time of the client end.

19. The invention as recited in claim 18, wherein the step of receiving the authentication approval message further includes a step of decrypting the authentication approval message.

20. The invention as recited in claim 14, wherein the authentication code is the client end's ID, password, and harddisk serial number.

21. The invention as recited in claim 14, wherein the authentication code is the client end's ID, password, and manufacture number.

22. The invention as recited in claim 14, wherein the step of verifying the authentication code through the database website and sending back an authentication approval message further includes the steps of:
confirming the difference between the authentication code and previous authentication code of the database download and installation; and
renewing the number of download and installation times.

23. The invention as recited in claim 22, wherein the download and installation times are download and installation, which have been already made.

24. The invention as recited in claim 22, wherein the download and installation times are remaining download and installation times.
